(19) United States
(12) Patent Application Publication
(10) Pub. No.: US 2009/0117879 A1
(43) Pub. Date: May 7, 2009

(54) MOBILE COMMERCE SYSTEM FOR CREATION OF ENFORCEABLE ORAL AGREEMENTS

(75) Inventors: Sharad Narayana Rao Pawar, San Diego, CA (US); Stewart A. Skomra, Poway, CA (US); Jeffrey William Vosburg, Oceanside, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/260,967

(22) Filed: Oct. 29, 2008

Related U.S. Application Data
(60) Provisional application No. 60/984,604, filed on Nov. 1, 2007.

(51) Int. Cl. H04M 1/725; G06Q 30/00

(52) U.S. Cl. 455/412.1; 705/80; 705/39

(57) ABSTRACT

The specification and drawing figures describe and show a mobile commerce system for creation of enforceable oral agreements. The system includes at least one mobile wireless communications instrument and a data processor operatively connected to the mobile wireless communications instrument. A recording subsystem is provided to record and archive information including identification, authorization, and authentication information. The system also includes means for disbursing and receiving digital currency. The system includes a dispute resolution protocol.

### CROSS-REFERENCE TO RELATED APPLICATION

As provided in 35 U.S.C. §119, this application claims priority to a co-pending provisional application, Application No. 60/984,604, filed Nov. 1, 2007 entitled Mobile Commerce System for Creation of Enforceable Agreements, assigned to the assignee of this application, the contents of which are incorporated by reference into this document.

### FIELD OF TECHNOLOGY

The system, apparatus and methods disclosed in this document pertain generally to creating an enforceable oral agreement using at least one mobile wireless communication instrument such as cell phone handsets and related programs. More particularly, the new and useful mobile commerce system for creation of enforceable oral agreements addresses and solves numerous legal, educational, traditional, currency, and cultural problems that may inhibit commerce not only in developing nations, but also in more sophisticated, or developed, nations. The mobile commerce system for creation of enforceable oral agreements is particularly, but not exclusively, useful for allowing users of a mobile wireless communication instrument to conduct a wide range of commercial and personal transactions, including the creation of enforceable oral agreements, without the need to memorialize the parties' agreement in a written document.

### BACKGROUND

Agreements, contracts and a range of other commercial and personal transactions (in this document, collectively “agreement” or “agreements”) often are delayed or avoided because of the perceived need to memorialize agreements as paper documents as a condition of or predicate to enforceability of such agreements. Continued exchanges between parties of varying drafts and/or versions of one or more documents introduce escalating costs associated with production, distribution, storage, retrieval, and reproduction of both electronic versions and paper versions of the documents leading to a final agreed on version of the agreement, almost always then reduced to a paper document. The process of exchanging drafts and/or versions of an agreement may introduce numerous unintended ambiguities and errors in the resulting documents. Additionally, written contracts often engender requirements for intermediaries such as witnesses, those who validate the documents and the information recited in the documents, and similar formalities, which seek to introduce and create trust between parties to a proposed transaction or agreement. However, such intermediaries may further compound costs and delays. These costs, delays and attendant problems of paper-based business processes are well known and well documented.

For expanding electronic and mobile-commerce markets, the direct and indirect costs associated with processing paper documents introduce unnecessary costs, inconveniences, and delays that inhibit potential large market segment adoptions not only for lower-income consumers in under-developed and emerging economy countries, but also in the fast-paced commerce of nations accustomed to sophisticated commercial and personal transactions.

While use of a mobile commerce system for creation of enforceable oral agreements would have universal application, such a system would be particularly useful in facilitating market development in developing economies. Economists have written widely about “Bottom of the Pyramid” (“BOP”) markets. BOP Markets comprise the world's 4 billion statistically poor. Product penetration in this market demands “essential for life” applications, namely products necessary to conduct a way of life. Major obstacles to market penetration in such markets include illiteracy despite multilingual capabilities of many of the illiterates. Because of illiteracy within the BOP market, most transactions are based on verbal assurances. Paper confirmations, memorializing transaction between and among parties, often are merely read to the illiterate who accept the terms and conditions of the written document using, for example, a finger print.

For the entire range of under-educated to well educated people to enter into oral agreements, identification and authentication of the parties, and acceptable and trustworthy authorization, are essential. A mobile commerce system for creation of enforceable oral agreements should be responsive to those needs and objectives, and for the range of needs and objectives between those who seek to conduct transactions in the BOP markets, and those who conduct their transactions in more sophisticated markets.

There appears to be no known commercial implementation of electronic solutions for addressing the dynamic creation of auditable, non-repudiable, enforceable agreements regarding transactions using digitized contextual solutions including, as one non-exclusive example, a mobile wireless communications instrument. A “smartcard” used in connection with an NFC-integrated cellular telephone has been suggested as a means to provide authentication for the purpose of conducting financial and other security transactions. As used in this document, the term “NFC” means “near-field communications.” However, there appears to be no suggestion to combine an NFC reader and a smartcard cellular telephone to solve the problem of creating enforceable oral agreements. NFC has not been tied or linked to the context of the environment in which a commercial transaction is executed. In other words, NFC has not been combined with apparatus for capturing images, audio negotiations, or biometric data of parties to an agreement. Any NFC-type system extended to help create enforceable oral commercial transaction would be unable to overcome the threshold problem of enrollment of participants within an NFC community in such a way as to appeal to lower income consumers or under-developed and emerging economy countries.

A need, therefore, exists for a new and useful system for creation of enforceable oral agreements for commercial and personal transactions.

### SUMMARY

In accordance with one aspect of this invention, a mobile commerce system for formation of an enforceable oral agreement includes a mobile wireless communications instrument, a data processor having logic operatively connected to the mobile wireless communications instrument adapted to receive, store, process, and transmit data and information across a wireless communications network, a recording subsystem operatively connected to the mobile wireless communications instrument adapted to record and archive oral negotiations of a plurality of parties across a wireless communications network, and a dispute resolution protocol adapted to resolve disputes between the parties regarding the oral negotiations and oral agreement.

In accordance with another aspect of this invention, an apparatus for forming an oral agreement includes means for receiving, storing, processing, and transmitting data and information across a wireless communications network; means operatively connectable to the receiving, storing, processing, and transmitting means for recording and archiving oral negotiations of at least two parties across a wireless communications network; and means included in the recording and archiving means for enforcing the oral agreement.

In accordance with another aspect of this invention, a storage medium containing computer software encoded in machine-readable format for allowing formation and enforcement of an oral agreement is included, wherein the computer software includes a set of computer instructions for identifying, authenticating, and locating a plurality of parties desiring to form and enforce the oral agreement; a set of computer instructions for recording oral negotiations of the plurality of parties; and a set of computer instructions for receiving, storing, processing, and transmitting the oral negotiations across a mobile wireless communications system.

In accordance with yet another aspect of this invention, a storage medium is provided that contains computer software encoded in machine-readable format for allowing formation and enforcement of an oral agreement, the computer software comprising a set of computer instructions for identifying, authenticating, and locating a plurality of parties desiring to form and enforce the oral agreement; a set of computer instructions for recording oral negotiations of the plurality of parties; a set of computer instructions for receiving, storing, processing, and transmitting the oral negotiations across a mobile wireless communications system; and a set of computer instructions for resolving a dispute arising from the oral agreement.

In accordance with another aspect of this invention, a method of forming an oral agreement includes providing to a party desiring to enter the oral agreement a mobile wireless communications instrument, wherein the mobile wireless communications instrument includes party identifying and authenticating devices; connecting the mobile wireless communications instrument to a location and position determination system; connecting the mobile wireless communications instrument and the location and position determination system across a network of servers; including a recording subsystem for recording and archiving oral negotiations related to the oral agreement; and resolving disputes that may arise in connection with the oral agreement.

In accordance with yet another aspect of this invention, a method of using a mobile wireless communications system to create and enforce an oral agreement includes selecting one or more mobile wireless communications instruments for use by parties seeking to negotiate the oral agreement; including in the plurality of mobile wireless communications instruments a data processor having logic operatively connected to the mobile wireless communications instrument for receiving, storing, processing, and transmitting identification and authentication data related to the parties across a wireless communications network related to the oral agreement; providing a recording subsystem operatively connectable to the plurality of mobile wireless communications instruments for recording oral negotiations of the parties; and including a dispute resolution protocol for resolving disputes that may arise in connection with the oral negotiations.

It will become apparent to one skilled in the art that the claimed subject matter as a whole, including the structure of the apparatus, and the cooperation of the elements of the apparatus, combine to result in a number of unexpected advantages and utilities. The structure and co-operation of structure of the system for creation of enforceable oral agreements will become apparent to those skilled in the art when read in conjunction with the following description, drawing figures, and appended claims.

The foregoing has outlined broadly the more important features of the invention to better understand the detailed description that follows, and to better understand the contributions to the art. The system for creation of enforceable oral agreements is not limited in application to the details of construction, and to the arrangements of the components, provided in the following description or drawing figures, but is capable of other embodiments, and of being practiced and carried out in various ways. The phraseology and terminology employed in this disclosure are for purpose of description, and therefore should not be regarded as limiting. As those skilled in the art will appreciate, the conception on which this disclosure is based readily may be used as a basis for designing other structures, methods, and systems. The claims, therefore, include equivalent constructions. Further, the abstract associated with this disclosure is intended neither to define the system for creation of enforceable oral agreements, which is measured by the claims, nor intended to limit the scope of the claims.

The novel features of the system for creation of enforceable oral agreements are best understood from the accompanying drawing, considered in connection with the accompanying description of the drawing, in which similar reference characters refer to similar parts, and in which:

### BRIEF DESCRIPTION OF THE DRAWING

FIG. 1 of the drawing is a diagrammatic representation illustrating at least one aspect of the system for creation of enforceable oral agreements;

FIG. 2 is a block diagram of one representation illustrating at least one aspect of the data processor of the system for creation of enforceable oral agreements;

FIG. 3 is a is a block diagram illustrating one aspect of the method of forming an oral agreement;

FIG. 4 is a flowchart of another aspect of a method of using a mobile wireless communications system to create and enforce an oral agreement; and

FIG. 5 is a flowchart of another aspect of a mobile commerce system for creation of enforceable oral agreements.

To the extent that the numerical designations in the drawing figures include lower case letters such as “a,b” such designations include multiple references, and the letter “n” in lower case such as “a-n” is intended to express repetitions of the element designated by that numerical reference and subscripts.

### DETAILED DESCRIPTION

### Definitions

As used in this document, the term “agreement” means an arrangement as to a course of action, a concord of understanding and intention between at least two parties with respect to the effect on the parties' relative rights and duties concerning past or future facts and circumstances. The term “agreement,” therefore is an all-encompassing, broader term than “contract.” The term “contract” generally means an agreement that may be supported by consideration, terms and conditions that are enforceable, although oral, at least under the dispute resolution protocol included in the system for creation of enforceable oral agreements disclosed in this document. Likewise, the term “commercial transaction” means not only contracts and other agreements, but also includes the wide variety of arrangements willingly entered into by parties including, but not limited to, leases, loans, security agreements, and the like.

The term “authentication” means at least to confirm, prove, and/or serve to prove that a person is who the person asserts the person is.

The term “authorization” means at least legal and/or custom that empowers a person to act or omit to act.

The terms “mobile wireless communications instrument” and/or “portable wireless communications instrument” as used in this document mean at least a wireless communication instrument used in a wireless communications system that, in general, includes an array of operatively connected communication components adapted to receive and transmit at least electromagnetic signals across the system without cables using infrared light and radio signals, and also includes a telecommunications system in which electromagnetic waves, rather than some form of wire, carry the signal over all or part of the communication path. The mobile wireless communications instrument may also receive and transmit signals including, location parameters, from satellites, including satellites that are part of the Global Positioning System (“GPS”), Galileo, GLONASS, NAVSTAR, GNSS, a system that uses satellites from a combination of these systems, or any satellite positioning system subsequently developed (collectively referred to generally in this document as a Satellite Positioning System (“SPS”). As used in this document, an SPS also includes pseudolite (pseudo-satellite) systems. As a person of skill in the art will appreciate, a mobile wireless communications system also may include terrestrial components, and may be used either independently of an SPS system, or in conjunction with an SPS system. A terrestrial-based position determination system may be used, as one non-exclusive example, to connection with Assisted GPS equipment and Local Positioning Systems (“LPS”) systems that may be associated with RFID and/or Wi-Fi RSSI system. As a person skilled in the art also will appreciate, however, the technology of SPS and terrestrial systems is constantly being improved. New as yet unknown technologies for location determination and for determining location parameters of use with the mobile commerce authentication and authorization system of this document may be developed, may be used in connection with the mobile commerce authentication and authorization system of this document, and are included in the meaning of “SPS” as used in this document.

The term “instrument” in combination with the words “mobile wireless communications,” means and includes at least a cellular telephone and a pager, a satellite telephone, a two-way pager, a personal digital assistant (“PDA”) having wireless capabilities, a portable computer having wireless capabilities, wireless local area networks, and any other type of wireless device having transmission capabilities that may also be one or more versions of a personal communications services device (“PCS”) including time division multiple access (“TDMA”), a code division multiple access (“CDMA”), a global system for mobile (“GSM”), non-voice communications apparatus, and text transmission apparatus, among others. The term “instrument” is also intended to include devices which communicate with a personal navigation device (“PND”), such as by short-range wireless, infrared, wireless connection, or other connection, regardless of whether satellite signal reception, assistance data reception, and/or position-related processing occurs at the device or at the PND. Also, “instrument” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network.

The term “location” and “position” mean the physical and geographic location of one or more mobile wireless communications instruments determined by any technique, technology, or system, or any combination of techniques, technologies, or systems, known or as yet unknown, for determining location parameters. Currently, such techniques and apparatus used for various wireless communication networks such as an SPS system in combination with a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN.

The term “credit network” means a national and/or worldwide system in which financial institutions, merchants, and public users are connectable. Credit networks were designed for use primarily with payment instruments. Payment instruments allow public users, or customers, to use, for example, a credit or debit card to purchase goods or services in substantially real time following authentication of the customer, authorization, and approval of the transaction by a financial institution. A user, or customer, is issued a payment instrument such as a credit or debit card after an account has been approved by the credit provider, often a financial institution such as a bank, with which the user is able to make purchases from merchants who accept the credit, up to a pre-established limit. In addition, a “card association” often is included in the credit network, and includes among others VISA® and MasterCard® which act as gateways between a financial institution and issuer for authorizing and funding transactions, the issuer being a financial institution or other organization that issued the credit/debit card to the cardholder.

The term “payment instrument” means at least a credit card, a debit card, a contactless card, debit lines, debit coupons, and cash equivalents.

The term “wireless communications network” means a wireless communications system adapted to communicate with one or more mobile wireless communications instruments, including not only the QUALCOMM® QSHOP™ system, but also any communications system capable of associating geographical location data with a mobile wireless communications instrument, a point-of-sale device in a merchant's store, and of transmitting between such geographic locations payment sums pertaining to a commercial transaction involving the sale and purchase of good and/or services, using SPS position-determination technology.

The term “subsystem” includes but is not limited to a back-office subsystem of a wireless communications network including the QUALCOMM Mobile Commerce Platform that includes QFLOW™. In the context of a recording subsystem, the subsystem also may be included a component of one or more wireless communications instruments.

### DESCRIPTION

The mobile commerce system for creation of enforceable oral agreements disclosed in this document addresses and satisfies the above needs by providing a mobile commerce system for creation of an enforceable oral agreement. The system includes at least one mobile wireless communications instrument capable of communicating across a mobile wireless communications system. As previously indicated, the system includes a mobile wireless communications instrument in the possession of at least one party proposing to enter into an oral agreement. While the mobile commerce system for creation of enforceable oral agreements may be used by parties geographically separated, who each therefore would use a mobile wireless communications instrument, the system also may be used by two or more parties who seek to use the system to memorialize an agreement using a single mobile wireless communications instrument. The system also includes a data processor. The data processor has logic operatively connected to the mobile wireless communications instrument, and is capable of receiving and transmitting data and information about the oral agreement and other commercial transactions. In addition, a recording subsystem is provided. The recording subsystem is operatively connected to the mobile wireless communications instrument to record and archive information about each party, authorization from each party, the negotiations between the parties leading to enforceable terms and conditions of the oral agreement. The system also includes means for disbursing and receiving digital currency to close and conclude the oral agreement and/or commercial transaction memorialized by the oral agreement. The system includes a dispute resolution protocol stored at least in the data processor, and in one aspect the protocol may consist of the parties' oral agreement to be bound, and to agree to resolve any dispute by any agreed on procedure.

As indicated, one of the unique features of the system for creation of enforceable oral agreements is availability of digital or other electronic currency for payment in connection with an oral agreement requiring payment to close the transaction. Digital currency is a form of electronic money. Digital currency may be denominated in a variety of already-existing currencies, sometimes called fiat currencies, including commodities deemed to have value such as gold and/or silver. Electronic, or digital, money is a representation of a system of debits and credits having an exchange value to the parties to an oral agreement, and may include currencies associated with conventional banking systems, or stand-alone systems. A private currency may use a commodity such as gold to provide extra security, or may simply rely on the consent of parties to the agreement.

Indeed, most money today is electronic. Tangible currency is becoming less frequently used in developing and developed nations. With the introduction of internet/online banking, credit cards and/or debit cards, online bill payments, internet business, the convention of use of paper money, like paper agreements, appears to be waning. For example, banks now offer many services allowing a customer to transfer funds, purchase stocks, make deposits to retirement plans, and so on, without either the bank or the customer conducting such transactions using cash or checks.

Parties to an agreement want evidence of trust and trustworthiness. Users of mobile wireless communications instruments, such as cellular telephones, desire to conduct and close purchases, sales, and other commercial transactions quickly, expeditiously, with trust in the procedure and substance of the transaction. In one aspect of the mobile commerce system for creation of enforceable oral agreements, authentication is achieved by use of biometric identification and mutual consent of the parties. Identification and consent are recorded and archived. Mutual assurance thus is achieved. At least one method of biometric authentication is finger print recognition technology, which may be further authenticated against a pre-existing database. Finger print identification, or similar means deemed trustworthy by the negotiating parties, will confirm (a) identify of the parties, (b) consent of the parties involved to record and archive the conversation, and to be bound by the dispute resolution protocol included with the mobile commerce system for creation of enforceable oral agreements, and (c) an agreement between the parties confirming the content and context of the verbal assurance.

In another aspect of the mobile commerce system for creation of enforceable oral agreements, use of mobile wireless communication instruments equipped with video, photographic, and including location determination, or “SPS,” capabilities, will enhance the perception of reliability and trustworthiness among contracting parties of the mobile commerce system for creation of enforceable oral agreements. SPS, for example, may confirm location and position of the parties to an agreement.

The system for creation of enforceable oral agreements is not limited to use of only digital or electronic currency for concluding commercial transactions by rendering payment for goods and/or services. The system also is capable of including conventional payment options such as those that exist in connection with a credit network. At least one non-exclusive example of such payment option is an existing arrangement between merchants, vendors, and credit card associations including VISA® and MasterCard® that act as gateways between a financial institution and an issuer for authorizing and funding purchases.

Current constructs for effecting consumer purchases across a financial institution credit network generally are limited to use of a payment instrument in connection with purchase. Currently, a consumer must have in possession a plastic payment instrument such as a credit card or debit card having a magnetic strip. At the point-of-sale, a credit card reader, terminal, or similar point-of-sale payment device is provided that requires the consumer to successfully swipe the payment instrument through the point-of-sale device. Over time, repetitive use degrades the magnetic strip on the payment instrument, and the data embedded in the magnetic strip may become unreadable by a point-of-sale device for a variety of reasons. Degradation of the magnetic strip may cause payment rejection although the consumer may be the authentic owner of the payment instrument. Authentication or verification of the customer is limited to data and information embedded in the magnetic strip of the payment instrument. Whoever possesses the payment instrument can affect purchases. The use of personal identification numbers neither solves the problems of customer identification nor customer authorization. Even customer authentication fails to overcome problems resulting from lost or stolen payment instruments, degraded instruments, or loss of functionality between the payment instrument and point-of-sale payment devices.

In under-developed areas of the world, many parties to a proposed agreement are unable to establish credit-worthiness sufficient to warrant issuance of a payment instrument. Accordingly, the system for creation of enforceable oral agreements does not require a party to an agreement to first have something such as a credit card, or to know something such as a password, a personal identification number, or personal details often forgotten.

The mobile commerce system for creation of enforceable oral agreements disclosed in this document uses audio and visual capture capabilities of mobile wireless electronic instruments to record conversations and images that confirm and record the context within which an agreement has been formed between two or more parties. The system includes what no paper contract documents normally include, namely the spatial, temporal and other bionic and biometric data associated with the context in which the negotiating and agreeing occurred.

In one aspect of the mobile commerce system for creation of enforceable oral agreements, the system captures digital information in the form of original data. The original data is marked with metadata that provide spatial, temporal, and biometric information about the parties and the subject matter of the commercial transaction. In addition, marking the data provides a unique signature of the context of the commercial transaction using a metadata encoding stream that captures the digital information, resulting in encoded data. The encoded data is useful to and usable by each party to the contract or commercial transaction, providing a record of the contract or transaction that the parties' negotiations established.

In another aspect of the mobile commerce system for creation of enforceable oral agreements, a mobile wireless communications instrument may be used to capture digital information in the form of screen images displayed on one or more other mobile wireless communications instruments to be included as information to be archived as part of the oral agreement. Such information may include, as indicated above, spatial, temporal, biometric and/or watermarked information supporting the oral negotiations leading to an oral agreement.

As indicated, authentication is desirable in oral agreements. The authenticity of the encoded data can be used to reproduce the metadata encoding stream through any of a number of processes applied to encoded data by using and comparing the original data. Likewise, authenticity may be enhanced by reproducing the original data from the encoded data using the metadata encoding stream.

The mobile commerce system for creation of enforceable oral agreements thus eliminates the need for paper to memorialize commercial transactions and contracts, and the burdensome problems of handling, reproducing, and storing paper contract and commercial documents. The mobile commerce system for creation of enforceable oral agreements also eliminates the need for intermediaries and the consequent delays associated with conventional contract processes.

The mobile commerce system for creation of enforceable oral agreements enables new business models for a host of commercial or non-commercial agreements supporting lower-income parties in emerging or underdeveloped market economies, as well as more sophisticated parties and transactions. The mobile commerce system for creation of enforceable oral agreements simplifies and accelerates contractual transactions agreements by its ease of generating non-repudiable and enforceable agreements.

In at least one aspect of the mobile commerce system for creation of enforceable oral agreements the system is fully compatible with, and capable of being used over, one or more cooperative message-forwarding systems linking computer networks around the world, such as the Internet (collectively in this document, “Internet”).

A party to a commercial transaction may want to impose additional limitations on authentication and authorization by oral negotiations that are recorded and archived for future confirmation and enforcement, if necessary.

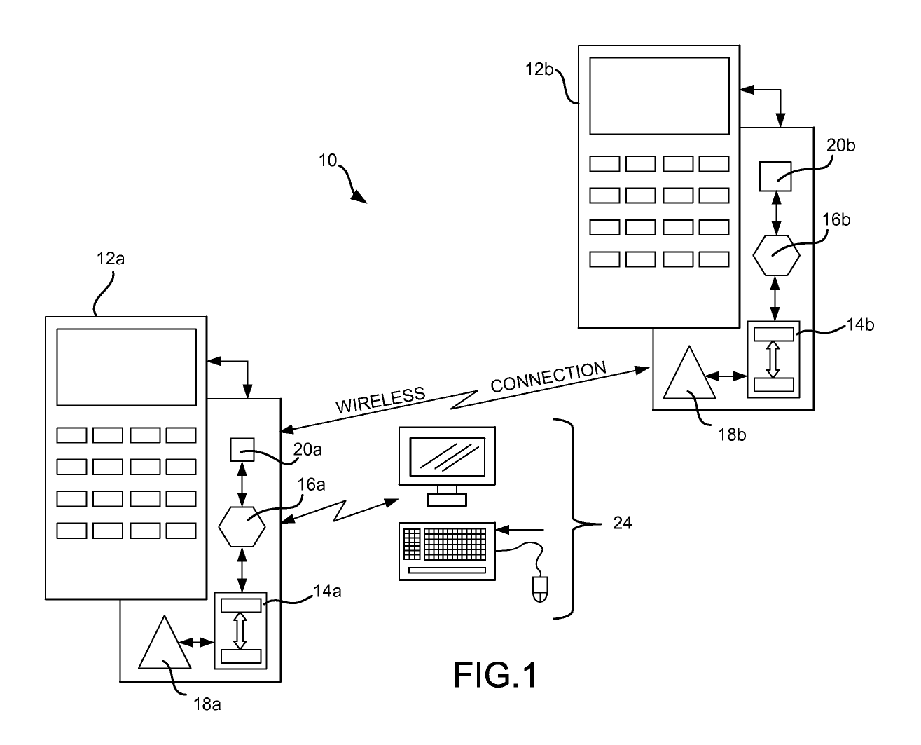

More specifically, one aspect of a mobile commerce system for creation of enforceable oral agreements 10 is illustrated in FIG. 1. As shown, the mobile commerce system for creation of enforceable oral agreements 10 includes at least one mobile wireless communications instrument 12. Mobile wireless communications instruments 12a,b more and more frequently are in the possession of parties who may desire to negotiate and close enforceable oral agreement and/or other commercial transactions. The mobile commerce system for creation of enforceable oral agreements 10 also includes a data processor 14. The data processor 14 has logic 16 operatively connected to the mobile wireless communications instruments 12a,b. The logic 16 that is operatively connected to the mobile wireless communications instruments 12a,b is illustrated in FIG. 1 diagrammatically as an aid in description. Logic 16 is capable of receiving and transmitting data and information about an oral agreement and other commercial transactions. In addition, at least one recording subsystem 18 is provided. The recording subsystem 18 is operatively connected to the mobile wireless communications instruments 12a,b to record and archive information that may include identification information about each party, but may also include information confirming the negotiations between the parties leading to enforceable terms and conditions of the oral agreement, and information demonstrating an agreement of the parties. The mobile commerce system for creation of enforceable oral agreements 10 also includes means for disbursing and receiving digital currency to close and conclude the oral agreement and/or commercial transaction memorialized by the oral agreement. In addition, the mobile commerce system for creation of enforceable oral agreements 10 includes a dispute resolution protocol 20 stored in either or both of the data processors 14a,b and/or in the at least one recording subsystem 18. In one aspect of application of the mobile commerce system for creation of an enforceable oral agreement 10, the parties agree orally to be bound by the dispute resolution protocol. The dispute resolution protocol 20 may be translated into any number of languages, dialects, and idioms. In another aspect, the dispute resolution protocol may be no more than an element agreed to by the parties during negotiations that, in event of a dispute, a licensed or unlicensed person, located at a location remote from the parties, will act either as an arbitrator or as a mediator who may, in addition to listening to the negotiations, also listen to the parties' comments about their interpretations of those negotiations to assist the arbitrator and/or mediator to make an informed decision to settle the dispute. In addition, as will become apparent subsequently, when the parties have identified the terms and conditions of the agreement that are mutually acceptable, each party is authenticated and verified against pre-recorded biometric signatures. The pre-recorded biometric signatures may be stored in a data processor having logic that is operatively connectable to the mobile wireless communications instrument, and/or in a recording subsystem that also is operatively connectable to the mobile wireless communications instrument.

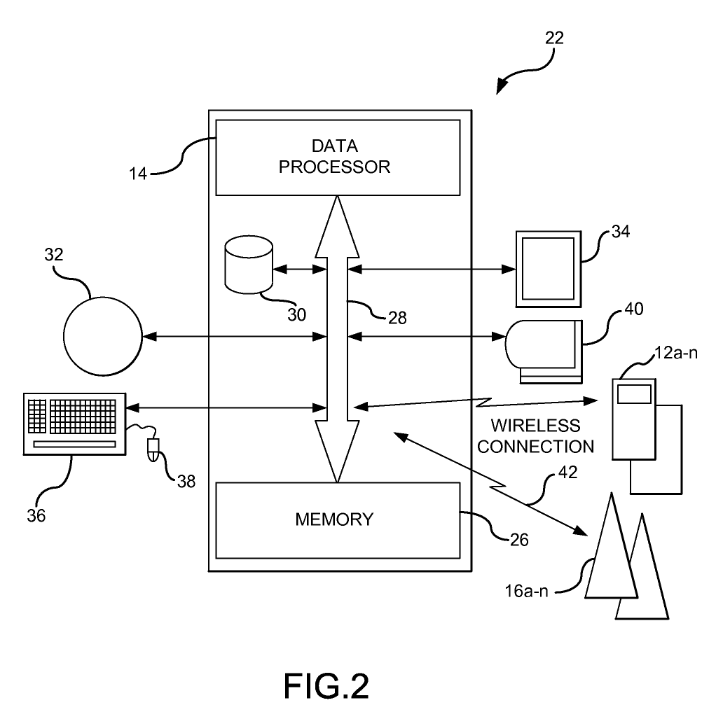

As illustrated in FIG. 2, the mobile communications instrument 12a,b includes a data processing system 22 as illustrated in a non-exclusive example in the block diagram in FIG. 2. As shown, the data processing system 22 may include a variety of components to enable the mobile communications instrument 12a-n to send and receive data and information, including image identification and image authentication, for use in the mobile commerce system for creation of enforceable oral agreements 10. As a person skilled in the art will recognize, all of the information and data received, processed, and transmitted by the mobile communications instrument 12a-b may be received, processed, and transmitted to a computer 24 or similar apparatus that also may function as a recording subsystem 18 as illustrated by cross-reference to FIG. 1.

As illustrated if FIG. 2, the data processing system 22 includes a data processor 14 and memory 26. A bus 28 connects the data processor 14 and memory 26. Memory 26 is a relatively high-speed machine-readable medium and may include volatile memories such as DRAM, and SRAM, as well as non-volatile memories such as ROM, FLASH, EPROM, EEPROM, and bubble memory. Also connectable to the bus 28 are optional secondary storage 30, external storage 32, output devices such as a monitor 34 that may be operatively connected to the mobile wireless communications instrument 12a-n, and in optional configurations an input device such as a keyboard 36 with a mouse 38, and perhaps a printer 40. Secondary storage 30 may include machine-readable media such as a hard disk drive, a magnetic drum, and bubble memory. External storage 32 may include machine-readable media such as a floppy disk, a removable hard drive, a magnetic tape, CS-ROM and even other data processors, possibly connected via a communications line 42 to one or more non-mobile communications devices 16a-n as illustrated by cross-reference to FIG. 1.

The distinction between secondary storage 30 and external storage 32 is primarily for convenience in describing the mobile commerce system for creation of enforceable oral agreements 10. As such, a person skilled in the art will appreciate that there is substantial functional overlap between and among the components. Data processor software and user programs can be stored in a software storage medium such as memory 26, secondary storage 30, and external storage 32. Executable versions of data processor software can be read from a storage medium such as non-volatile memory, loaded for execution directly into volatile memory, executed directly out of non-volatile memory, or stored in the secondary storage 30 prior to loading into volatile memory for execution.

In addition, those skilled in the art also will appreciate that the various illustrative logical blocks, modules, circuits, and algorithm steps described in this document may be implemented as electronic hardware, data processor software, or combination of both. To clearly illustrate this interchangeability of hardware and software, various illustrative and non-exclusive components, blocks, modules, circuits, and steps have been described in this document generally in terms of their functionality. Whether such functionality is implemented as hardware or software depends on the particular application and design constraints imposed on an overall system. Skilled artisans may implement the described functionality in varying ways for each particular application, but such implementation decisions should not be interpreted as causing a departure from the scope of the present invention.

Likewise, the various illustrative logical blocks, modules, and circuits described in connection with the system for medication management disclosed in this document may be implemented or performed with a general purpose data processor, a Digital Signal Processor (“DSP”), an Application Specific Integrated Circuit (“ASIC”), a Field Programmable Gate Array (“FPGA”) or other programmable logic device, discrete gate or transistor logic, discrete hardware components, or any combination thereof, designed to perform the functions described in this document. A general-purpose processor may be a microprocessor, but in the alternative, the processor may be a conventional processor, controller, microcontroller, or state machine. A processor may also be implemented as a combination of computing devices such as, in a non-exclusive example, a combination of a DSP and a microprocessor, a plurality of microprocessors, one or more microprocessors in conjunction with a DSP core, or any other such configuration.

Those of skill in the art also would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

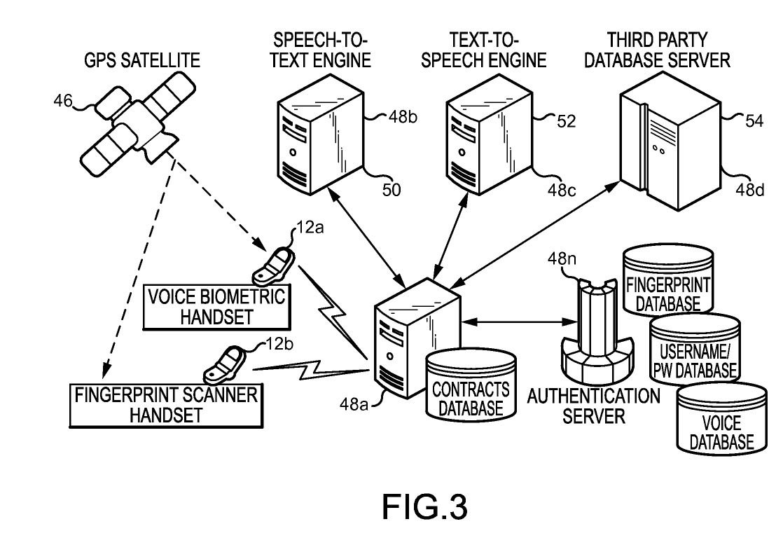

Referring now to FIG. 3, the method of forming an oral agreement 10 is illustrated in a block diagram. As illustrated, the method of forming an oral agreement 10 includes providing to a party desiring to enter into an oral agreement a mobile wireless communications instrument 12. The mobile wireless communications instrument 12 includes technologies for identifying and authenticating the parties to a proposed oral agreement 10. As shown, the mobile wireless communications instrument 12 may include identifying and authenticating technologies including voice identification systems. In addition, or alternatively, biometric identification systems may be included with the mobile wireless communications instrument 12. Likewise, fingerprint scanning technologies may be included with the mobile wireless communications instrument 12. The mobile wireless communications instrument may be a cellular telephone, but as a person skilled in the art will recognize, the mobile wireless communications instrument may be any of a number of communications instruments mentioned in this document.

As also illustrated in FIG. 3, the mobile wireless communications instrument 12 is connected to a location and position determination system 46. As illustrated, and as described in this document, the location and position determination system 46 may be a GPS satellite position determination system, or in a broader sense an SPS system, and in some cases may also include terrestrial location and position determination systems (not shown).

As also shown in FIG. 3, the mobile wireless communications instrument 12 is operatively connectable to one or more servers 48a-n to indicate that there will be a number of servers. For example, the mobile wireless communications instrument 12 may be operatively connectable to a server 48a having a contracts data base for archiving the oral agreement and a number of other oral agreements. In addition, a speech-to-text engine 50 may be provided for memorializing the oral agreement into text. Alternatively, or additionally, a server 48c having text-to-speech capabilities 52 may also be provided for converting written documents to oral recordings. Similarly, a server 48d may be provided to operate as a wireless server hub 54. In addition, a server 48n dedicated to authentication of the parties and of the transaction may be provided. The authentication server 48n is capable of confirming biometric, voice, fingerprint, and similar data related to identification and authentication of the parties to the oral agreement.

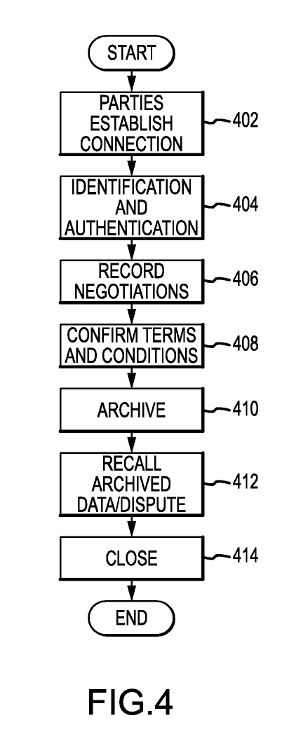

FIG. 4 is another aspect of a method of using a mobile wireless communications system to create and enforce an oral agreement. FIG. 4 consists of a flowchart 400. As illustrated in FIG. 4, at block 402 parties proposing to create an oral agreement have established a connection with one another using a mobile wireless communications system to which a plurality of mobile wireless communications instruments 12 are connectable for use by the parties seeking to negotiate the oral agreement. As previously indicated, however, a person skilled in the art will appreciate that a single mobile wireless communications instrument may be used by a plurality of parties to memorialize an oral agreement. The plurality of mobile wireless communications instruments 12a,b include at least a data processor 14 as illustrated by cross-reference between FIGS. 1-2. The data processor includes logic 16 that is operatively connectable to the mobile wireless communications instrument 12 for receiving, storing, processing, and transmitting across the wireless communications network data and information that identifies and authenticates the parties to the oral agreement as illustrated at block 404. In addition, as illustrated at block 406, a recording subsystem 18 that is operatively connectable to the plurality of mobile wireless communications instruments 12a,b is provided for recording the oral negotiations of the parties.

The terms and conditions of the oral agreement, as illustrated at block 408, may be confirmed by the parties in any manner acceptable to the parties. The oral negotiations, as well as confirmation of the terms and conditions, may be archived as illustrated in block 410. The archived voice data may be supplemented by visual representations that may also be transmitted between the mobile wireless communications instrument 12 across the mobile wireless communications system. The combination of oral negotiations, confirmation of the terms and conditions, and any accompanying visual data exchanged between the parties may be archived in a wireless server hub and/or any of a number of alternative servers. Thus, data related to the location of the parties to the oral agreement obtainable from a terrestrial and/or satellite position location determination system may also be archived in the one or more servers. One or more of the servers may function as an authentication server for storage and retrieval of data related to identifying the parties to the transaction, and is further archived as illustrated at block 410. As illustrated at block 412, any and all of the data pertaining to the negotiations, the confirmation of the transaction, and any supporting visual data may be recalled from the one or more servers used to archive the data. This would be particularly important should a dispute arise. The archived data could be used, for example, to refresh the memory of one or more of the contracting parties to the terms and conditions of their oral agreement so as to eliminate or resolve the dispute. At block 414, the transaction agreed to by the party is closed upon completion of the terms and conditions of the oral agreement.

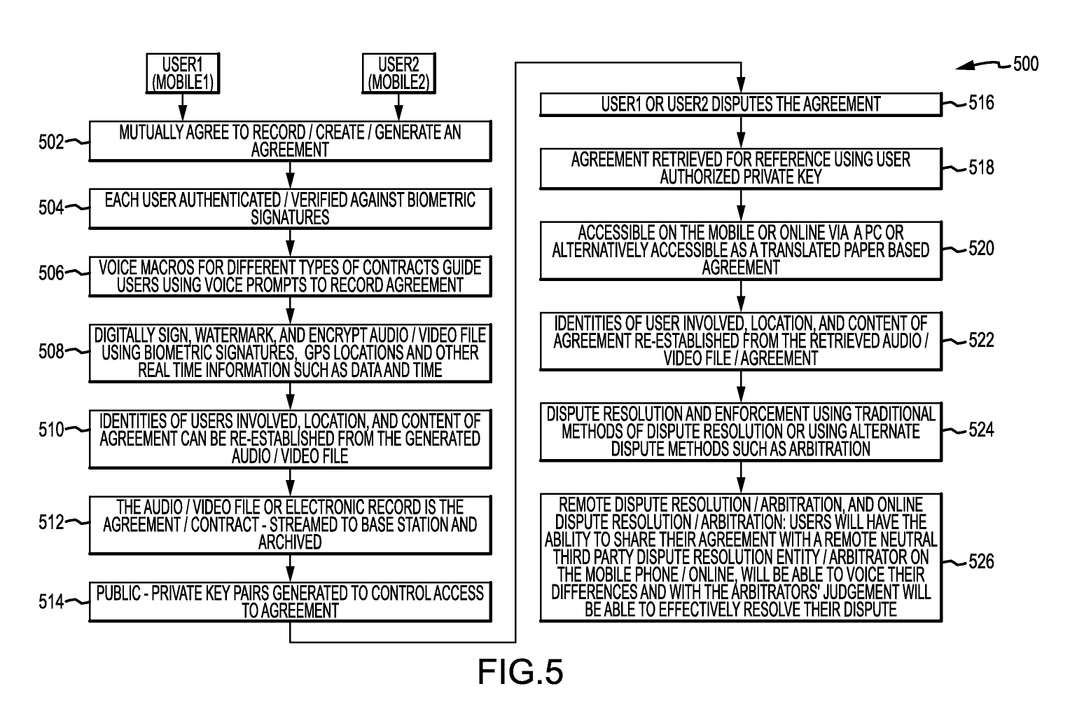

Another aspect of the mobile commerce system for creation of enforceable oral agreements is illustrated in flowchart 500 in FIG. 5. As illustrated in FIG. 5, two “start” events in connection with the flowchart are contemplated representing two different users of mobile wireless communication instruments, such as cellular telephones, illustrating two users who desire to enter into negotiations leading to an enforceable oral agreement. At block 502 the two users (in this document, “parties”) mutually agree to record the terms and conditions of their agreement across the mobile commerce system for creation of enforceable oral agreements and to thereby generate an agreement. At block 504, having identified the terms and conditions of the agreement that are mutually acceptable, each party is authenticated and verified against pre-recorded biometric signatures. The pre-recorded biometric signatures may be stored in a data processor having logic that is operatively connectable to the mobile wireless communications instrument, and/or in a recording subsystem that also is operatively connectable to the mobile wireless communications instruments.

As also illustrated in flowchart 500 at FIG. 5, a variety of technologies may be included in the mobile commerce system for creation of enforceable oral agreements. Thus, at block 506, voice macros for different types of agreements and contracts are provided to guide the parties through the process of creating an enforceable oral agreement by including prompts to record terms and conditions of an agreement. Voice macros are provided for a number of different but common agreements that would fit the contracting objectives of the parties. In addition, the ability of the parties to rely on performance of the agreement by each of the parties is enhanced by providing technologies to digitally sign, watermark, and encrypt audio and/or video files using biometric signatures; to determine the location of the parties to assist in identifying the parties; and can store, record, and transmit other information, substantially in real time, including the date and time of the negotiations and formation of the enforceable oral agreement. Accordingly, at block 510 the parties to the oral agreement are fully identified, their locations are known, and the content of the oral agreement may be re-established from an audio and/or video file generated in the future, as needed.

At block 512, the method of a mobile commerce system for creation of enforceable agreements provides for the streaming the audio and/or video files, and any associated electronic record containing the terms and agreements of the oral agreement, to a base station (in this document, “data transmission subsystem”) for archival located in a wireless service hub or other server. As illustrated at block 514, public and private key pairs must be generated to control access to the recorded and archived oral agreement.

Block 516 anticipates the possibility of a dispute arising between the parties to the agreement. In the event of a dispute contemplated at block 516, at block 518 the oral agreement is retrieved for reference using authorized private keys of the parties. Likewise, at block 520 the oral agreement may be accessed on both of the mobile wireless communications instruments, or online using a personal computer or other mobile wireless communications instrument identified in this document. As also noted at block 520, a paper version of the oral agreement, translated to the language best approximating the language of the parties to the oral agreement, can be obtained as illustrated by cross-reference to FIG. 4. During preparations to resolve the dispute between the parties, as indicated at block 522 the identities of the parties, their locations, and the content of the oral agreement is re-established from the retrieved audio and/or video files. Thus, at block 524, resolution of the dispute, and enforcement of the oral agreement, may be affected using traditional methods of dispute resolution, as well as alternative methods of dispute resolution such as mediation and/or arbitration. Thus, as indicated at block 526, at least one advantage of the mobile commerce system for creation of enforceable oral agreements is that the dispute resolution may be conducted even though parties are at remote locations in relation to one another. Likewise, either mediation and/or arbitration may be conducted instead of judicial determinations. As indicated, the parties will have the ability to share the oral agreement with a remote mutual third party who may mediate, arbitrate, or render a decision, if necessary, in connection with enforcement of the oral agreement, while the parties, even though remote, will be able to present their perspectives of what the oral agreement was intended to achieve. As a result, the parties will be able to inexpensively and quickly resolve a dispute.

The previous description of the disclosed aspects is provided to enable any person skilled in the art to make or use the present invention. Various modifications to these embodiments will be readily apparent to those skilled in the art, and the generic principles defined in this document may be applied to other embodiments without departing from the spirit or scope of the invention. Thus, the present invention is not intended to be limited to the aspects shown in this document, but is to be accorded the widest scope consistent with the principles and novel features disclosed herein.

Claim elements and steps in this document have been numbered solely as an aid in understanding the description. The numbering is not intended to, and should not be considered as intending to, indicate the ordering of elements and steps in the claims. In addition, the mobile commerce system for creation of enforceable oral agreements shown in drawing FIG. 1 shows at least one aspect of the mobile commerce system for creation of enforceable oral agreements, is not intended to be exclusive, but merely illustrative of the disclosed embodiments.

1. A mobile commerce system for formation of an enforceable oral agreement, comprising:
a mobile wireless communications instrument;
a data processor having logic operatively connected to the mobile wireless communications instrument adapted to receive, store, process, and transmit data and information across a wireless communications network;
a recording subsystem operatively connected to the mobile wireless communications instrument adapted to record and archive oral negotiations of a plurality of parties across a wireless communications network; and
a dispute resolution protocol adapted to resolve disputes between the parties regarding the oral negotiations and oral agreement.

2. A mobile commerce system for formation of an enforceable oral agreement as recited in claim 1, further comprising a data transmission subsystem located in a wireless service hub adapted to receive, store, process, and transmit across the wireless communications network at least the oral negotiations.

3. A mobile commerce system for formation of an enforceable oral agreement as recited in claim 2, further comprising a location determination system operatively connectable to the mobile wireless communications instrument and to the wireless service hub adapted to identify the location of the plurality of parties.

4. A mobile commerce system for formation of an enforceable oral agreement as recited in claim 3, wherein the dispute resolution protocol is stored in at least in the data processor and in the wireless service hub.

5. A mobile commerce system for formation of an enforceable oral agreement as recited in claim 1, further comprising a plurality of mobile wireless communications instruments possessed by the plurality of parties.

6. A mobile commerce system for formation of an enforceable oral agreement as recited in claim 1, further comprising means for disbursing and receiving digital currency related to the oral agreement.

7. A mobile commerce system for formation of an enforceable oral agreement as recited in claim 1, further comprising means for including the oral agreement as an element of consideration to support of the oral agreement.

8. A mobile commerce system for formation of an enforceable oral agreement as recited in claim 1, wherein the recording subsystem includes audio, aural, image, and video recording and transmitting capabilities.

9. A mobile commerce system for formation of an enforceable oral agreement as recited in claim 1, wherein the data processor having logic includes means for identifying the plurality of parties.

10. A mobile commerce system for formation of an enforceable oral agreement as recited in claim 1, wherein the data processor having logic includes means for authenticating the plurality of parties.

11. A mobile commerce system for formation of an enforceable oral agreement as recited in claim 1, wherein the data processor having logic includes means for digitally encrypting the data and information of the data processor.

12. An apparatus for forming an oral agreement, comprising:
means for receiving, storing, processing, and transmitting data and information across a wireless communications network;
means operatively connectable to the receiving, storing, processing, and transmitting means for recording and archiving oral negotiations of at least two parties across a wireless communications network; and
means included in the recording and archiving for enforcing the oral agreement.

13. An apparatus for forming an oral agreement as recited in claim 12, wherein the means for receiving, storing, processing, and transmitting means includes a mobile wireless communications instrument.

14. An apparatus for forming an oral agreement as recited in claim 12, wherein the means for receiving, storing, processing, and transmitting means includes a cellular telephone.

15. An apparatus for forming an oral agreement as recited in claim 12, wherein the means for receiving, storing, processing, and transmitting means includes a wireless service hub.

16. An apparatus for forming an oral agreement as recited in claim 12, wherein the means for receiving, storing, processing, and transmitting means includes a data processor located in the means for receiving, storing, processing, and transmitting.

17. An apparatus for forming an oral agreement as recited in claim 12, further comprising means operatively connectable to the means for receiving, storing, processing, and transmitting, and to the means for recording and archiving, for determining location of the at least two parties.

18. An apparatus for forming an oral agreement as recited in claim 12, wherein the means for recording and archiving includes means for recording and archiving audio, aural, image, and video data and information.

19. An apparatus for forming an oral agreement as recited in claim 12, wherein the means for receiving, storing, processing, and transmitting includes means for identifying and authenticating the at least two parties.

20. A storage medium containing computer software encoded in machine-readable format for allowing formation and enforcement of an oral agreement, the computer software comprising:
a set of computer instructions for identifying, authenticating, and locating a plurality of parties desiring to form and enforce the oral agreement;
a set of computer instructions for recording oral negotiations of the plurality of parties;
a set of computer instructions for receiving, storing, processing, and transmitting the oral negotiations across a mobile wireless communications system; and
a set of computer instructions for resolving a dispute arising from the oral agreement.

21. A storage medium containing computer software encoded in machine-readable format for allowing parties to form and enforce an oral agreement as recited in claim 20, wherein the set of computer instructions for identifying and authenticating a plurality of parties desiring to form and enforce the oral agreement is located in a data processor.

22. A storage medium containing computer software encoded in machine-readable format for allowing parties to form and enforce an oral agreement as recited in claim 20, wherein the data processor is located in:
A. a plurality of mobile wireless communications instruments;
B. a recording subsystem located in the plurality of mobile wireless communications instruments; and/or
C. a wireless server hub.

23. A storage medium containing computer software encoded in machine-readable format for allowing parties to form and enforce an oral agreement as recited in claim 20, further comprising a set of computer instructions for effecting payment in connection with the oral agreement.

24. A method of forming an oral agreement, comprising:
providing to a party desiring to enter the oral agreement a mobile wireless communications instrument,
wherein the mobile wireless communications instrument includes party identifying and authenticating devices;
connecting the mobile wireless communications instrument to a location and position determination system;
connecting the mobile wireless communications instrument and the location and position determination system across a network of servers;
including a recording subsystem for recording and archiving oral negotiations related to the oral agreement; and
resolving disputes that may arise in connection with the oral agreement.

25. A method of forming an oral agreement as recited in claim 24, wherein providing a mobile wireless communications instrument includes providing a cellular telephone.

26. A method of forming an oral agreement as recited in claim 24, wherein the party identifying and authenticating devices include voice readers and transmitters.

27. A method of forming an oral agreement as recited in claim 24, wherein the party identifying and authenticating devices include biometric readers and transmitters.

28. A method of forming an oral agreement as recited in claim 24, wherein the party identifying and authenticating devices include fingerprint scanners and transmitters.

29. A method of forming an oral agreement as recited in claim 24, wherein connecting the mobile wireless communications instrument to a location and position determination system includes:
operatively connecting the mobile wireless communications instrument to a satellite location determination system; and/or
operatively connecting the mobile wireless communications instrument to a terrestrial location determination system.

30. A method of forming an oral agreement as recited in claim 24, wherein connecting the mobile wireless communications instrument and the location and position determination system across a network of servers includes connecting the mobile wireless communications instrument and the location and position determination system to:
a server having a contracts database for archiving the oral agreement;
a server having a speech-to-text engine for memorializing the oral agreement into text;
a server having a text-to-speech engine for converting written documents to oral recordings;
a server capable of operating as a wireless server hub; and/or
a server capable of confirming biometric, voice, fingerprint, and similar data related to identifying and authenticating the party.

31. A method of using a mobile wireless communications system to create and enforce an oral agreement, comprising:
selecting one or more mobile wireless communications instruments for use by parties seeking to negotiate the oral agreement;
including in the plurality of mobile wireless communications instruments a data processor having logic operatively connected to the mobile wireless communications instrument for receiving, storing, processing, and transmitting identification and authentication data related to the parties across a wireless communications network related to the oral agreement;
providing a recording subsystem operatively connectable to the plurality of mobile wireless communications instruments for recording oral negotiations of the parties; and
including a dispute resolution protocol for resolving disputes that may arise in connection with the oral negotiations.

32. A method of using a mobile wireless communications system to create and enforce an oral agreement as recited in claim 31, wherein selecting one or more mobile wireless communications instruments includes selecting a mobile wireless cellular telephone.

33. A method of using a mobile wireless communications system to create and enforce an oral agreement as recited in claim 32 further comprising including in the mobile wireless communications system a wireless server hub having a data transmission subsystem for receiving, storing, processing, and transmitting across the wireless communications network oral negotiation data between the parties.

34. A method of using a mobile wireless communications system to create and enforce an oral agreement as recited in claim 33, further comprising including a location determination system operatively connectable to the mobile wireless communications instrument and to the wireless service hub adapted to identify the location of the plurality of parties.

35. A method of using a mobile wireless communications system to create and enforce an oral agreement as recited in claim 34, wherein including a data processor having logic operatively connected to the mobile wireless communications instrument for receiving, storing, processing, and transmitting identification and authentication data related to the parties across a wireless communications network includes voice, biometric, fingerprint and similar identification and authentication data.

36. A method of using a mobile wireless communications system to create and enforce an oral agreement as recited in claim 35, wherein including a data processor having logic operatively connected to the mobile wireless communications instrument for receiving, storing, processing, and transmitting identification and authentication data related to the parties across a wireless communications network includes encrypting the identification and authentication data.

37. A method of using a mobile wireless communications system to create and enforce an oral agreement as recited in claim 36, wherein providing a recording subsystem operatively connectable to the one or more mobile wireless communications instruments for recording oral negotiations of the parties further comprises operatively connecting the recording subsystem to a plurality of servers.

38. A method of using a mobile wireless communications system to create and enforce an oral agreement as recited in claim 37, wherein operatively connecting the recording subsystem to a plurality of servers includes at least connecting the recording subsystem to a plurality of servers capable of:
archiving the oral agreement;
memorializing the oral agreement into text;
converting written documents to oral recordings;
operating as a wireless server hub; and/or
confirming biometric, voice, fingerprint, and similar data related to identifying and authenticating the parties.
